(19) United States
(12) Patent Application Publication
(10) Pub. No.: US 2015/0153597 A1
(43) Pub. Date: Jun. 4, 2015

(54) LIQUID CRYSTAL COATING METHOD AND METHOD FOR MANUFACTURING LIQUID CRYSTAL DISPLAY PANEL

(71) Applicant: SHENZHEN CHINA STAR OPTOELECTRONICS TECHNOLOGY CO. ,LTD., Shenzhen, Guangdon (CN)

(72) Inventor: Ming Liu, Shenzhen (CN)

(21) Appl. No.: 14/241,816

(22) PCT Filed: Jan. 21, 2014
(86) PCT No.: PCT/CN2014/070976

§ 371 Date: Feb. 27, 2014

(30) Foreign Application Priority Data
Nov. 21, 2013 (CN) 201310594860.8

(51) Int. Cl. G02F 1/1341

(52) U.S. Cl. CPC G02F 1/1341; G02F 2001/13415

(57) ABSTRACT

The present application relates to a liquid crystal coating method and a method for manufacturing a liquid crystal display panel. The liquid crystal coating method comprises the following steps: (a) arranging, on one side of a first transparent substrate, a frame that protrudes out of a plane of the substrate; (b) coating an area surrounded by the frame with predetermined amount of liquid crystal; (c) coupling a second transparent substrate with the surface of the first transparent substrate which is coated with the liquid crystal; and (d) spreading liquid crystal over the area surrounded by the frame under the action of the second transparent substrate. The liquid crystal coating method and the method for manufacturing a liquid crystal display panel according to the present disclosure can effectively control the additive amount of liquid crystal, thus improving the yield of finished display and reducing the production cost.

### FIELD OF THE INVENTION

The present disclosure relates to a liquid crystal coating method. The present disclosure father relates to a method for manufacturing a liquid crystal display panel using the liquid crystal coating method.

### BACKGROUND OF THE INVENTION

With the continuous development of flat panel display technology, various types of flat panel displays emerge in the market, for example, thin-film field-effect transistor liquid crystal display (TFT-LCD), plasma display panel (PDP), light-emitting diode (LED), and the like. Among the various display technologies, liquid crystal display technology is the most mature and the most accepted by consumers. Therefore, liquid crystal displays are the most widely used.

Take the production of a TFT-LCD as an example. Two glass substrates coupled to each other are provided, wherein a circuit matrix and the like are formed on one glass substrate, and a color filter is formed on the other. The space between the two glass substrates is injected with liquid crystal, sealant is coated, and then the two glass substrates are coupled together. After a few subsequent procedures, finished products are available for consumers.

In the manufacturing process of the TFT-LCD display, injection of liquid crystal is the most critical step. In the prior art, the mass or volume of the liquid crystal injected cannot be controlled accurately, causing a waste of the liquid crystal. Because liquid crystal is very expensive, profit brought by the existing production mode is correspondingly low. In addition, various quality problems to the finished display can be caused by imprecise control over the amount of the liquid crystal. For example, too much liquid crystal can cause defects like uneven brightness, and inadequate liquid crystal can cause defects such as bubbles and the like. Thus, discard or degradation of the final products can be caused.

### SUMMARY OF THE INVENTION

To solve the technical problems in the prior art, the present disclosure provides a method of liquid crystal coating. With the method, the additive amount of liquid crystal can be effectively controlled, thereby increasing the yield of the display. The present disclosure further relates to a method for manufacturing a liquid crystal display panel using the method of liquid crystal coating.

(1) According to a first aspect of the present disclosure, a method of liquid crystal coating is provided, comprising the following steps:

(a) arranging, on one side of a first transparent substrate, a frame that protrudes out of a plane of the substrate;

(b) coating an area surrounded by the frame with predetermined amount of liquid crystal;

(c) coupling a second transparent substrate with the surface of the first transparent substrate which is coated with the liquid crystal; and

(d) spreading liquid crystal over the area surrounded by the frame under the action of the second transparent substrate.

In the method according to the present disclosure, because the liquid crystal stays within the area defined by the frame all the time, when arranging the second transparent substrate, the liquid crystal material will not overflow, thus saving the liquid crystal used and reducing the production cost of the display. In addition, under the extrusion force of the second transparent substrate, the liquid crystal can fully and rapidly spread over the area surrounded by the frame, thus saving the time for the natural spreading and flattening of liquid crystal drops. Therefore, the work efficiency can be improved.

(2) In one embodiment according to (1), in step (b), the amount of the liquid crystal is determined by the volume of the area surrounded by the frame. The area to be coated with liquid crystal is enclosed by the frame arranged in advance, so that the amount of the liquid crystal needed can be determined effectively, thus preventing the injection volume of liquid crystal from being too large or too small, and further eliminating corresponding problems to the display.

(3) In one of the embodiments of (1) or (2), in step (b), liquid crystal coating is completed by dripping a plurality of liquid crystal drops on the area surrounded by the frame. In one preferable embodiment, the amount of liquid crystal in each drop is the same. Under the condition that the amount of liquid crystal in each drop is known, the liquid crystal coating by dripping liquid crystal drops enables the amount of liquid crystal needed to be accurately controlled by controlling the number of liquid crystal drops. In a specific embodiment, liquid crystal coating can be implemented by using a flow controller which can control the outflow of the liquid crystal each time. The flow controller can be one of a nozzle injection valve, a solenoid control valve, and a pressure control valve.

(4) In one embodiment of (3), the liquid crystal drops are uniformly distributed in the area surrounded by the frame. The liquid crystal drops dispersed in this way facilitates rapid spreading of liquid crystal over the area surrounded by the frame in a later period, thus the work efficiency can be improved.

(5) In any one of the embodiments of (1) to (4), the first transparent substrate and the second transparent substrate are glass substrates.

(6) According to a second aspect of the present disclosure, a method for manufacturing a liquid crystal display panel is provided, including the above liquid crystal coating method.

(7) In one embodiment of (6), sealant is further applied on an outer area of the frame of the first transparent substrate or the second transparent substrate, so that the first transparent substrate and the second transparent substrate can be coupled together. In one preferable embodiment, the area surrounded by the frame is the same in size as the display area of the liquid crystal display panel. This method for manufacturing the liquid crystal display panel can save the usage amount of liquid crystal, lower the production cost, shorten the processing time, and improve the work efficiency.

Compared with the prior art, the present disclosure has the following advantages. (1) The frame is arranged on the transparent substrate, then the liquid crystal is filled in the area surrounded by the frame, so that the liquid crystal will not overflow in the subsequent procedures, thus saving the liquid crystal and lowering the production cost of the display. (2) Due to the extrusion force of the second transparent substrate on the liquid crystal drops, the liquid crystal material can fully and rapidly spread over the area surrounded by the frame, thus saving the time in the natural diffusion and flattening of liquid crystal drops, thereby improving the work efficiency. (3) The amount of liquid crystal is determined by the volume of the area surrounded by the frame, and each drop has the same amount of liquid crystal. In this way, the amount of the liquid crystal can be accurately controlled by controlling the number of liquid crystal drops. The liquid crystal drops are uniformly distributed over the area surrounded by the frame, thus fully and rapidly spreading liquid crystal over the area surrounded by the frame in a later period, thereby improving the work efficiency.

### BRIEF DESCRIPTION OF THE DRAWINGS

The present disclosure will be described in more detail below based on the embodiments with reference to the accompanying drawings, in which:

FIG. 1 and FIG. 2 schematically show the step of coating the liquid crystal drops; and

FIG. 3 schematically shows the step of bonding the second transparent substrate.

In the accompanying drawings, the same components are indicated by the same reference signs. The accompanying drawings are not drawnto actual scale.

### DETAILED DESCRIPTION OF THE EMBODIMENTS

The present disclosure will be further illustrated below in conjunction with the accompanying drawings.

A method of liquid crystal coating according to the present disclosure comprises the following steps.

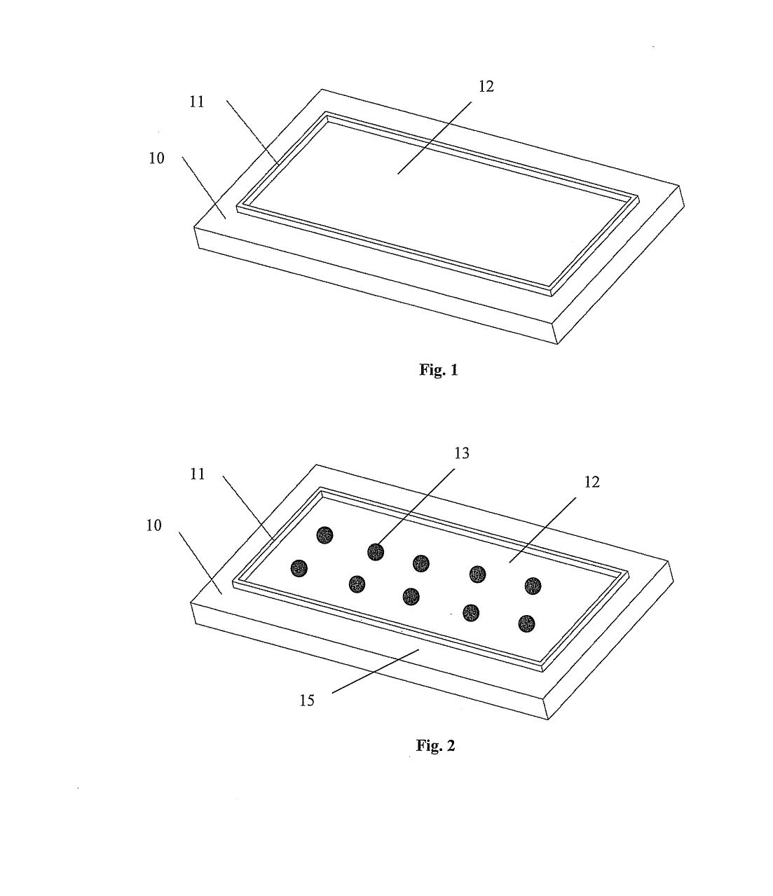

In step (a), a frame 11 is arranged on one side surface of a first transparent substrate 10, so that the frame 11 protrudes out of a plane of the substrate, as shown in FIG. 1. In the field of liquid crystal display, the first transparent substrate 10 is usually a glass substrate. The material of the frame 11 can be selected as needed, for example, red color-resist material, a green color-resist material, a blue color-resist material, a black matrix material, a spacer material, and the like. The frame 11 should be higher than the estimated height of the liquid crystal, so as to surround the liquid crystal material completely (which will be described below). In one embodiment, the height of the frame 11 can be in a range from 1.5 to 2.5 μm, preferably 2 μm. An area 12 surrounded by the frame 11 is preferably the same in size as the display area (not shown) of the liquid crystal display panel, thus greatly simplifying the manufacturing steps of the liquid crystal display panel.

In step (b), the area 12 surrounded by the frame 11 is coated with fixed amount of liquid crystal, as shown in FIG. 2. The amount of liquid crystal to be injected is determined by the volume of the area surrounded by the frame 11. For example, the volume of the liquid crystal injected is equal to the volume of the area surrounded by the frame 11. There are certainly other methods to measure the amount of the liquid crystal injected herein, such as by means of mass.

Preferably, the liquid crystal coating is implemented by dripping a plurality of liquid crystal drops 13 on the area 12 surrounded by the frame. Each liquid crystal drop 13 contains the same amount of liquid crystal, for example, the mass of each liquid crystal drop 13 can be 0.2 mg. Under the condition that the amount of each drop of liquid crystal is known, the liquid crystal coating by dripping liquid crystal drops enables the amount of the liquid crystal injected to be controlled accurately by controlling the number of the liquid crystal drops. Because liquid crystal is expensive, accurately controlling the liquid crystal filling amount can lower the production cost. In one specific embodiment, liquid crystal coating can be implemented by using a flow controller which can control the outflow of the liquid crystal each time. The flow controller can be one of a nozzle injection valve, a solenoid control valve, and a pressure control valve. In one preferred embodiment, a plurality of liquid crystal drops 13 is uniformly distributed on the area 12 surrounded by the frame, as shown in FIG. 2, thus fully and rapidly spreading the liquid crystal over the area 12 surrounded by the framein a later period Therefore, the work efficiency can be improved.

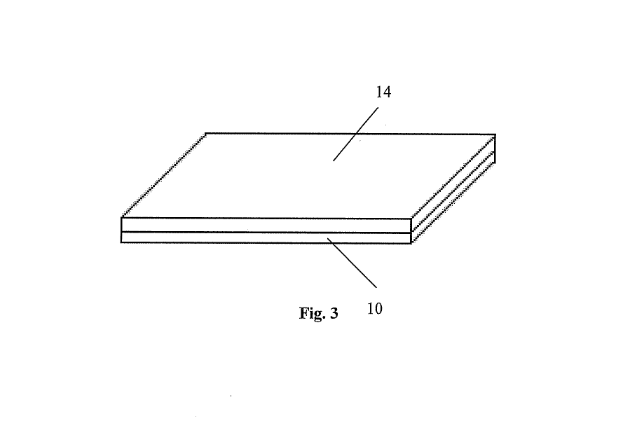

In step (c), a second transparent substrate 14 is coupled with the surface of the first transparent substrate 10 which is coated with liquid crystal, as shown in FIG. 3. In the field of liquid crystal display, the second transparent substrate 14 is preferably a glass substrate.

In step (d), the liquid crystal over the area 12 surrounded by the frame is fully spreaded under the action of the second transparent substrate 14. Under the extrusion action of the second transparent substrate 14, the liquid crystal material can rapidly and fully spread over the area 12 surrounded by the frame, thus saving the time in natural spreading and flattening of liquid crystal drops 13. Therefore the work efficiency can be improved.

The present disclosure further relates to a method for manufacturing a liquid crystal display panel, including the liquid crystal coating method. According to the method for manufacturing the liquid crystal display panel, the area 12 surrounded by the frame 11 is the same in size as the display area of the liquid crystal display panel.

In addition, the method for manufacturing the liquid crystal display panel further comprises coating an area 15 at the outer side of the frame 11 of the first transparent substrate 10 or the second transparent substrate 14 with sealant (not shown), in order to couple the first transparent substrate 10 and the second transparent substrate 14 together.

Although the present disclosure has been described with reference to the preferred examples, various modifications could be made to the present disclosure without departing from the scope of the present disclosure and components in the present disclosure could be substituted by equivalents. Particularly, as long as there is no structural conflict, all technical features mentioned in all the embodiments may be combined together in any manner. The present disclosure is not limited to the specific examples disclosed in the description, but includes all technical solutions falling into the scope of the claims.

1. A method of liquid crystal coating, comprising the following steps of:
(a) arranging, on one side of a first transparent substrate, a frame that protrudes out of a plane of the substrate,
(b) coating an area surrounded by the frame with predetermined amount of liquid crystal,
(c) coupling a second transparent substrate with the surface of the first transparent substrate which is coated with the liquid crystal, and
(d) spreading liquid crystal over the area surrounded by the frame under the action of the second transparent substrate.

2. The method according to claim 1, wherein in step (b), the amount of the liquid crystal provided is determined by the volume of the area surrounded by the frame.

3. The method according to claim 2, wherein in step (b), liquid crystal coating is completed by dripping a plurality of liquid crystal drops on the area surrounded by the frame.

4. The method according to claim 3, wherein the liquid crystal drops are uniformly distributed in the area surrounded by the frame.

5. The method according to claim 3, wherein the amount of liquid crystal in each liquid crystal drop is the same.

6. The method according to claim 5, wherein liquid crystal coating can be implemented by using a flow controller which can control the outflow of the liquid crystal each time.

7. The method according to claim 6, wherein the flow controller can be one of a nozzle injection valve, a solenoid control valve, and a pressure control valve.

8. The method according to claim 5, wherein the first transparent substrate and the second transparent substrate are glass substrates.

9. A method for manufacturing a liquid crystal display panel, including a step of liquid crystal coating, which comprises the following substeps of:
(a) arranging, on one side of a first transparent substrate, a frame that protrudes out of a plane of the substrate,
(b) coating an area surrounded by the frame with predetermined amount of liquid crystal,
(c) coupling a second transparent substrate with the surface of the first transparent substrate which is coated with the liquid crystal, and
(d) spreading liquid crystal over the area surrounded by the frame under the action of the second transparent substrate.

10. A method for manufacturing a liquid crystal display panel, including a step of liquid crystal coating, which comprises the following substeps of:
(a) arranging, on one side of a first transparent substrate, a frame that protrudes out of a plane of the substrate,
(b) coating an area surrounded by the frame with predetermined amount of liquid crystal,
(c) coupling a second transparent substrate with the surface of the first transparent substrate which is coated with the liquid crystal, and
(d) spreading liquid crystal over the area surrounded by the frame under the action of the second transparent substrate,
wherein in step (b), the amount of the liquid crystal provided is determined by the volume of the area surrounded by the frame, and the liquid crystal coating is completed by dripping a plurality of liquid crystal drops on the area surrounded by the frame, the amount of liquid crystal in each liquid crystal drop being the same.

11. The method according to claim 10, wherein further comprising applying sealant on an outer area of the frame of the first transparent substrate or the second transparent substrate, so that the first transparent substrate and the second transparent substrate can be coupled together.

12. The method according to claim 11, wherein the area surrounded by the frame is the same in size as the display area of the liquid crystal display panel.
